(19) United States
(12) Patent Application Publication
(10) Pub. No.: US 2021/0235188 A1
(43) Pub. Date: Jul. 29, 2021

(54) WEARABLE MICROPHONE SPEAKER

(71) Applicant: SHARP KABUSHIKI KAISHA, Sakai City (JP)

(72) Inventor: TATSUYA NISHIO, Sakai City (JP)

(21) Appl. No.: 17/154,641

(22) Filed: Jan. 21, 2021

(30) Foreign Application Priority Data
Jan. 27, 2020 (JP) 2020-010797

(51) Int. Cl. H04R 1/40; H04R 3/00; H04R 3/12; H04R 1/02; H04R 1/04

(52) U.S. Cl. CPC H04R 1/406; H04R 1/403; H04R 3/005; H04R 2201/401; H04R 1/025; H04R 1/04; H04R 3/12

(57) ABSTRACT

A wearable microphone speaker includes a main body that can be attached, one or a plurality of first microphones that are provided in the main body and pick up the voice of a talker, and a speaker unit that is provided in the main body and outputs sound to the talker. The first microphone has directionality in a direction of the talker's mouth. The speaker unit is arranged outside a directionality range of the first microphone.

### BACKGROUND OF THE INVENTION

### Field of the Invention

The present invention relates to a wearable microphone speaker that can be worn on the body and used.

### Description of the Background Art

A general speaker system has a merit that a plurality of people can hear at the same time, and a headphone or earphone has a merit that, though only one person can hear, the surrounding sounds are blocked. On the other hand, there is a demerit that the speaker system could be a noise to a third party, and the surrounding sound cannot be heard by the headphone or the like. In recent years, speaker devices that are worn on parts other than the ears for use have also been used to solve the demerits of speaker systems and headphones.

In addition, in a scene of a voice conference such as a web conference or a video conference, a remote conference is conducted by voice via a telephone line or an IP network, and it is required that a plurality of people make communication while acquiring the voice of the other party. In such scenes, use of a headset (wearable device) is also known in order to prevent surrounding sounds from interfering with the conference. For example, WO2018/051663 discloses a device including a microphone into which a talker's voice is input and a speaker which outputs voice input from an outside, as this type of wearable device.

In the voice conference scene as above, a wearable microphone speaker that can prevent unpleasant phenomena such as echo and howling and facilitate conversation is in demand. In addition, a talker speaks without fixing the direction of the face to the front, such as directing only the face sideways while using an electronic blackboard or speaking with movement for explanation in many cases. Therefore, there is a problem that a distance between the talker's mouth and the microphone is easily changed and the voice is hardly picked up in some cases.

In the wearable device disclosed in WO2018/051663, a correct worn state is required, and on the premise that the talker is facing the front, signal processing by a plurality of different arithmetic units that acquire the coordinates of the mouth is also needed, which causes a problem that the configuration becomes complicated and the cost increases.

The present invention has been made in view of the above-mentioned problems, and an object of the present invention is to provide a wearable microphone speaker which can capture a voice even if a talker speaks without fixing the direction of the face to the front and can be realized with a simple configuration and a low cost.

### SUMMARY OF THE INVENTION

A solution of the present invention for achieving the above object is a wearable microphone speaker characterized by including a main body that can be attached to a talker, one or a plurality of first microphones that are provided in the main body and pick up the voice of the talker, and one or a plurality of speakers that are provided in the main body and output sound to the talker, and the first microphone has directionality in the direction of the talker's mouth, and the speaker is arranged outside a directionality range of the first microphone.

Moreover, in the wearable microphone speaker having the above configuration, it is preferable that the speaker has directionality in the direction of the talker's ear.

Furthermore, in the wearable microphone speaker having the above configuration, the main body may be a neck band type that can be attached to the neck of the talker, and the first microphone may be provided on an attachment portion extending from above the shoulder to the chest side of the talker.

Furthermore, in the wearable microphone speaker having the above configuration, a plurality of the first microphones may be provided close to a distal end of the attachment portion located on the chest side, and the first microphones may be aligned closer to an inner side of the attachment portion, toward the distal end side of the attachment portion.

Furthermore, in the wearable microphone speaker having the above configuration, the main body may include a second microphone arranged outside the directionality range of the speaker, and the second microphone is preferably arranged on a side opposite to the first microphone with respect to the speaker.

Furthermore, in the wearable microphone speaker having the above configuration, the speaker may be disposed at a position corresponding to the lower part of the talker's ear, and the first microphone, the speaker, and the second speaker may be aligned on the attachment portion in order from the distal end side.

Furthermore, in the wearable microphone speaker having the above configuration, the attachment portion may be provided so as to be rotatable with respect to the main body, or may be provided extendably with respect to the main body.

According to the present invention, it is possible to capture the voice even if a person speaks without fixing the direction of the face to the front, and a wearable microphone speaker can be realized at a low cost without requiring a complicated configuration.

### BRIEF DESCRIPTION OF THE DRAWINGS

FIG. 1 is a front view showing a wearable microphone speaker according to a first embodiment of the present invention.

FIG. 2 is a perspective view showing an example of attachment of the wearable microphone speaker of FIG. 1.

FIG. 3 is a perspective view showing a modified example of the wearable microphone speaker according to the first embodiment of the present invention.

FIG. 4 is a perspective view showing a wearable microphone speaker according to a second embodiment of the present invention.

FIG. 5 is a perspective view showing a modified example of the wearable microphone speaker according to the second embodiment of the present invention.

FIG. 6 is a perspective view showing a wearable microphone speaker according to a third embodiment of the present invention.

FIG. 7 is a perspective view showing a wearable microphone speaker according to a fourth embodiment of the present invention.

FIG. 8 is a perspective view showing a modified example of the wearable microphone speaker according to the fourth embodiment of the present invention.

FIG. 9 is a perspective view showing a wearable microphone speaker according to a fifth embodiment of the present invention.

FIG. 10 is a perspective view showing a modified example of the wearable microphone speaker according to the fifth embodiment of the present invention.

FIG. 11 is a perspective view showing a modified example of the wearable microphone speaker according to the fifth embodiment of the present invention.

FIG. 12 is a perspective view showing a modified example of the wearable microphone speaker according to the fifth embodiment of the present invention.

FIG. 13 is a perspective view showing a wearable microphone speaker according to a sixth embodiment of the present invention.

FIG. 14 is a diagram showing an example of a microphone polar pattern having unidirectionality.

FIG. 15 is a diagram showing an example of a microphone polar pattern having super directionality.

### DESCRIPTION OF THE PREFERRED EMBODIMENTS

Hereinafter, the wearable microphone speaker 1 according to the embodiments of the present invention will be described with reference to the drawings.

### First Embodiment

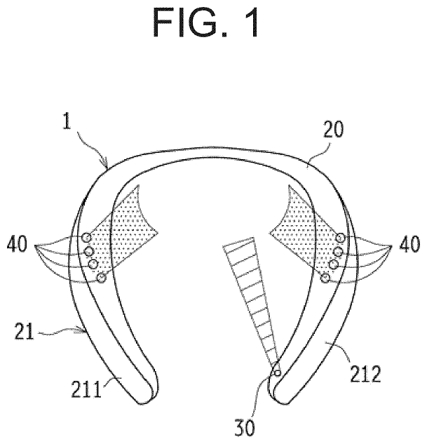

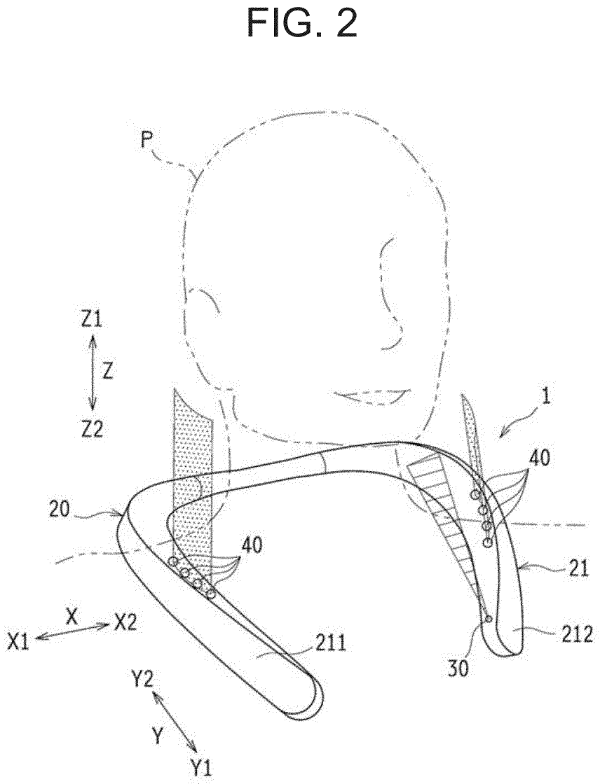

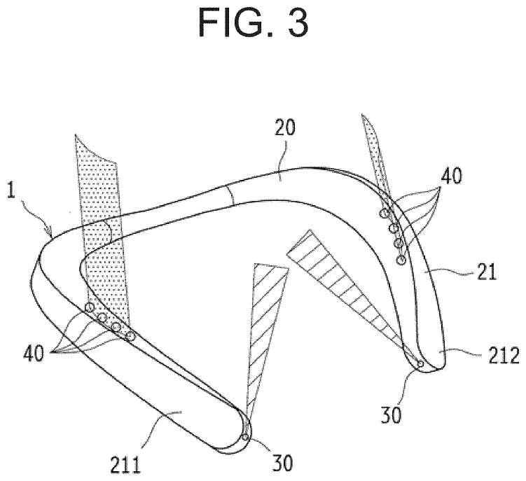

FIG. 1 is a front view showing a wearable microphone speaker 1 according to a first embodiment of the present invention, and FIG. 2 is a perspective view showing a state in which a talker P wears the wearable microphone speaker 1. FIG. 3 is a perspective view showing a modified example of the wearable microphone speaker 1 according to the first embodiment.

In the explanation according to the following embodiments, the directions such as front/rear/left/right in the wearable microphone speaker 1 are shown in the left-right direction X (right side X1, left side X2), the front-rear direction Y (front Y1, rear Y2), and the up-down direction Z (up Z1, down Z2) for the talker P wearing the wearable microphone speaker 1 as shown in FIG. 2.

The wearable microphone speaker 1 according to the first embodiment has a main body 20 attached to the talker P, and a first microphone 30 and a speaker unit 40 provided in the main body 20. As shown in FIG. 1, the main body 20 includes a substantial U-shape or a substantially annular shape when viewed from the front, and an attachment portion 21 (right-side attachment portion 211, left-side attachment portion 212) extending from the central part in both the front right and the front left.

This main body 20 is a neck band type that can be attached to the neck of talker P, and the first microphone 30 is provided on the attachment portion 21 that extends from above the shoulder to the chest side. As shown in FIG. 2, as one of the usage patterns of the wearable microphone speaker 1, the central part of the main body 20 is positioned at the rear Y2 of the neck of the talker P, and the other parts of the main body 20 can be used in a neck-mounted state, which is arranged from both sides of the neck of the talker P to the front Y1.

In the exemplified form, the left side attachment portion 212, which is one of the attachment portions 21 of the main body 20, includes the first microphone 30 having directionality. The first microphone 30 does not have sensitivity in all directions, but has directionality specified in the direction of the talker P's mouth, and picks up the voice of the talker P. The shaded area shown in each figure schematically shows an image of the directionality range and does not limit the directionality range in the wearable microphone speaker 1.

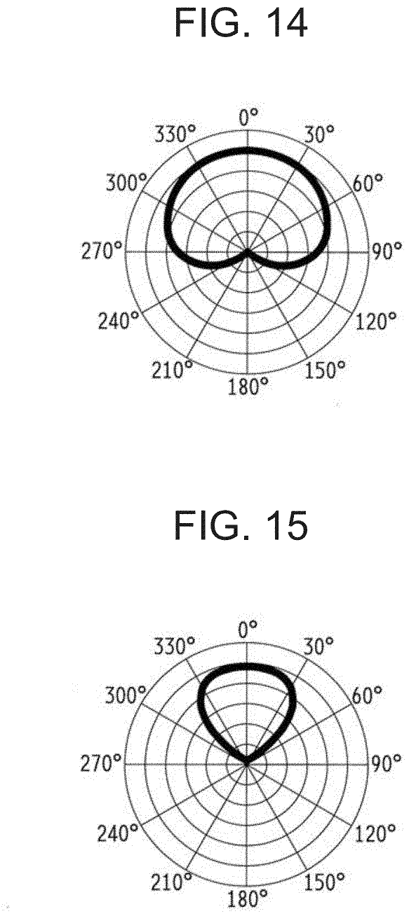

In the present embodiment, the directionality means unidirectionality, which is a directional characteristic that makes it easy to capture sound in the front direction, or super directionality, which is a directional characteristic with a narrower angle, and is characterized to have an insensitive region (direction) in a polar pattern. FIG. 14 is a diagram showing an example of a microphone polar pattern having unidirectionality, and FIG. 15 is a diagram showing an example of a microphone polar pattern having super directionality. In FIGS. 14 and 15, 0° corresponds to the mouth direction of the talker 2 in FIG. 2.

As shown in FIG. 15, a microphone having super directionality has strong directionality in a range of approximately 60° around the mouth direction (0°). For this reason, the super directional microphone rarely picks up noise from the side direction (90°, 270°). The first microphone 30 is preferably a directional microphone having unidirectionality or super directionality.

Of both distal ends of the main body 20, assuming that a part having a predetermined length from the distal end of the right side X1 is the right side attachment portion 211 and a part having a predetermined length from the distal end of the left side X2 is the left side attachment portion 212, the first microphone 30 is disposed, for example, on the left side attachment portion 212. In particular, in the examples shown in FIGS. 1 and 2, the first microphone 30 is provided at the distal end of the left side attachment portion 212. The main body 20 may include a microphone amplifier circuit or an A/D converter that amplifies a sound signal acquired by the first microphone 30 and outputs sound data to a controller (not shown).

A speaker unit 40 as a speaker is a sound output unit that outputs sound to the talker P and is arranged outside the directionality range of the first microphone 30. In this case, the first microphone 30 has directionality in the direction of the talker P's mouth, whereas the speaker unit 40 has directionality toward the ear of the talker P.

As shown in FIGS. 1 and 2, two speaker units 40 are provided in the main body 20, one is aligned on the right side attachment portion 211 and the other on the left side attachment portion 212. These speaker units 40 are preferably, for example, line array speakers aligned side by side in a row or a parametric speaker in which ultrasonic elements are aligned in an array, emit sound waves as a linear sound source and reduce interference of back pressure of the adjacent speaker units.

The directionality of the speaker unit 40 can be appropriately set by, for example, adjusting a mounting angle when the line array speaker is installed, or adjusting the orientation of each speaker in the line array speaker. For example, the directionality with diffusion of sound in the aligned direction suppressed can be obtained by arranging the speakers in the same direction.

As shown in FIG. 2, when the wearable microphone speaker 1 is attached around the neck of the talker P, the first microphone 30 has directionality in the direction of the talker P's mouth, and the speaker unit 40 is located at the down Z2 of the ear of the talker P and has directionality toward the ear. According to the wearable microphone speaker 1 configured as above, the voice emitted from the talker P is suitably acquired by the first microphone 30, and the sound emitted from the speaker unit 40 is clearly heard by the talker P. Moreover, since the ears are not covered, the talker P can speak while listening to the voices of others and the surrounding sounds, can make the use thereof suitable in conversation with a plurality of people or while moving, and can smoothly proceed with sound conferences, and the like. Furthermore, by attaching the wearable microphone speaker 1 around the neck, it can be worn close to the ears, the sound field does not change much even if it moves, and a sufficient sound pressure can be obtained even at a low volume.

The first microphone 30 may be provided not only at one of distal ends of the main body 20, but also at both the distal ends of the left attachment portion 212 and the right attachment portion 211 as shown in FIG. 3. Moreover, the wearable microphone speaker 1 is not limited to the neck band type shown in this embodiment, and as long as it has a configuration that can be worn on the body for use, it may have any configuration such that can be hung on the talker's neck with a strap or the like or attached to the talker's chest, abdomen, arms, and the like, with a belt or the like, for example, and the same applies to each of embodiments described below.

### Second Embodiment

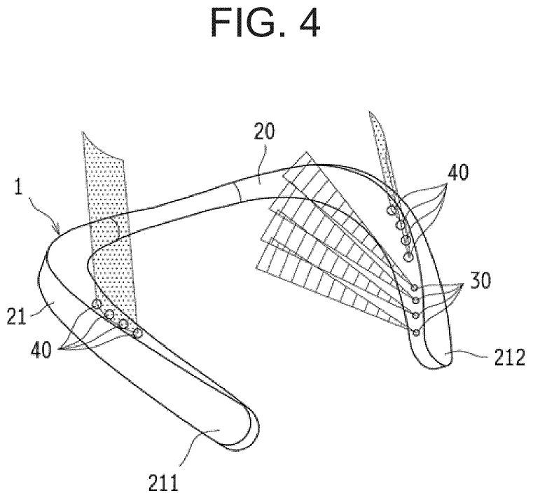

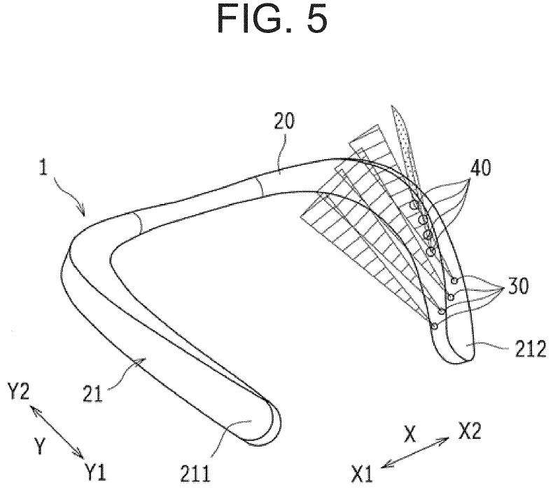

FIG. 4 is a perspective view showing the wearable microphone speaker 1 according to a second embodiment, and FIG. 5 is a perspective view showing a modified example of the wearable microphone speaker 1 according to the second embodiment.

The wearable microphone speaker 1 according to the second to sixth embodiments described below has basic configuration of the main body 20 similar to the first embodiment, and is characterized in the arrangement form, and the like, of the first microphone 30 and the speaker unit 40. Therefore, in the following description, the feature parts of each embodiment will be described in detail, and other configurations will be indicated by the same reference numerals as those in the first embodiment, and duplicate explanations will be omitted.

In the wearable microphone speaker 1, a plurality of the first microphones 30 arranged at a predetermined distance from each other may be provided on the left side attachment portion 212 (or the right side attachment portion 211). As shown in FIG. 4, in the wearable microphone speaker 1, the plurality of first microphones 30 mounted on the main body 20 are provided on the left attachment portion 212. The plurality of first microphones 30 are aligned close to the distal end of the left attachment portion 212. The plurality of first microphones 30 have directionality in the direction of the mouth and forms an array microphone aligned in a row.

In the exemplary embodiment, four first microphones 30 are aligned in one direction at an interval from each other. These first microphones 30 are provided so that the distance between the mouth of the talker P (see FIG. 2) with the wearable microphone speaker 1 worn by the talker P and each of the first microphones 30 is different.

The plurality of first microphones 30 can efficiently pick up and emphasize the voice of the talker P by beamforming processing. Moreover, in the sound processing circuit, the phases of a plurality of sound signals may be adjusted in response to the plurality of first microphones 30, and the reconverted sound can be reinforced and picked up by using the existing beamforming technology.

Furthermore, as shown in FIG. 5, the plurality of first microphones 30 may be aligned side by side in order from the inner side to the outer side of the attachment portion 21. In the exemplary embodiment, the four first microphones 30 are aligned from the distal end (chest side) of the front Y1 on the left side attachment portion 212 to the rear Y2 (direction to above the shoulder) so as to be located gradually to the outer side (the right side X1 to the left side X2 in the left side attachment portion 212).

By providing the plurality of first microphones 30 as above, the talker P can speak with his/her face directed sideways or while moving his/her face, and the directionality can be made to follow movement of the position of the mouth. In particular, as shown in FIG. 5, the plurality of first microphones 30 are aligned gradually to the outer side from the front Y1 to the rear Y2 so that the sound can be picked up correspondingly to the positions of the mouth when the talker P moves his/her face sideways, respectively. Alignment of the plurality of first microphones 30 is not limited to one row, but may be aligned in a plurality of rows. Moreover, the plurality of first microphones 30 are not limited to provision on the left side attachment portion 212 but may be provided on the right side attachment portion 211, or even may be provided on both the left and right attachment portions 21 (right side attachment portion 211 and left side attachment portion 212).

### Third Embodiment

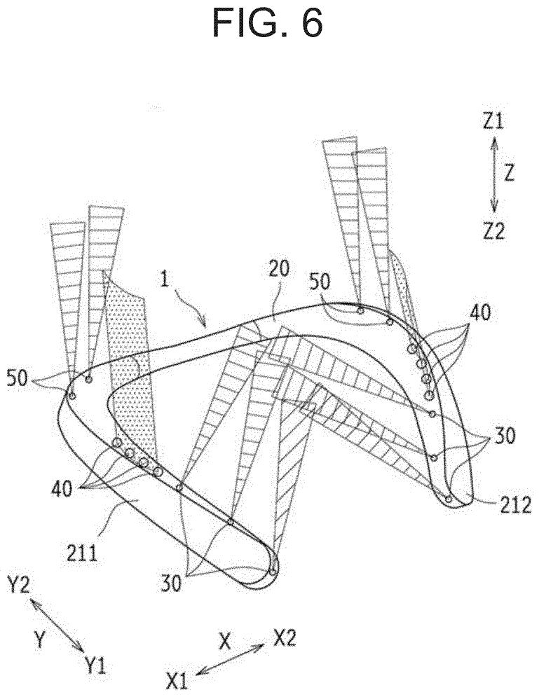

FIG. 6 is a perspective view showing the wearable microphone speaker 1 according to the third embodiment. The wearable microphone speaker 1 according to this form includes second microphones 50 arranged outside the directionality range of the speaker unit 40 in addition to the first microphone 30 and the speaker unit 40, in the main body 20.

As shown in FIG. 6, the main body 20 of the wearable microphone speaker 1 includes a plurality of the first microphones 30 and the speaker units 40 in each of the right side attachment portion 211 and the left side attachment portion 212. The second microphones 50 are arranged on a side opposite to the first microphones 30 with respect to the speaker unit 40. That is, the second microphones 50 are arranged at the rear Y2 of each speaker unit 40 in the right side attachment portion 211 and the left side attachment portion 212.

In this case, the speaker unit 40 is disposed at a position corresponding to the down Z2 of the talker P's ear and has directionality in the ear direction. The first microphone 30 has the directionality in the direction of the talker P's mouth. The first microphones 30, the speaker units 40, and the second microphones 50 are aligned in this order from the distal end side (the front Y1) on the right side attachment portion 211 and the left side attachment portion 212, respectively.

A plurality of the second microphones 50 are arranged behind the speaker unit 40 in the rear Y2. These second microphones 50 have the directionality of the up Z1 with respect to the main body 20 and are arranged outside the directionality range of the speaker unit 40. The second microphone 50 may have an outward directionality with respect to the main body 20 as long as it is outside the directionality range of the speaker unit 40.

The plurality of first microphones 30 and the plurality of second microphones 50 do not require beamforming. Therefore, complicated signal processing is not required, and no electronic board for control or the like is required, either. Because of being provided with the plurality of first microphones 30 and second microphones 50 arranged in the distributed manner in the front-rear direction Y, the wearable microphone speaker 1 can handle an emitted voice regardless of the direction in which the talker P's face moves. Moreover, since the second microphone 50 has the up Z1 or outward directionality, it can reliably pick up the voice of the talker P with his/her face directed sideways.

### Fourth Embodiment

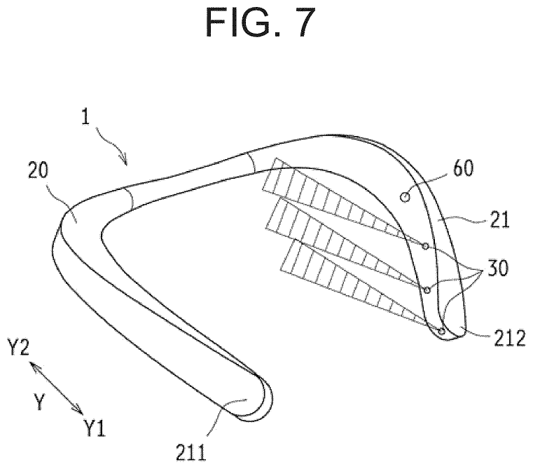

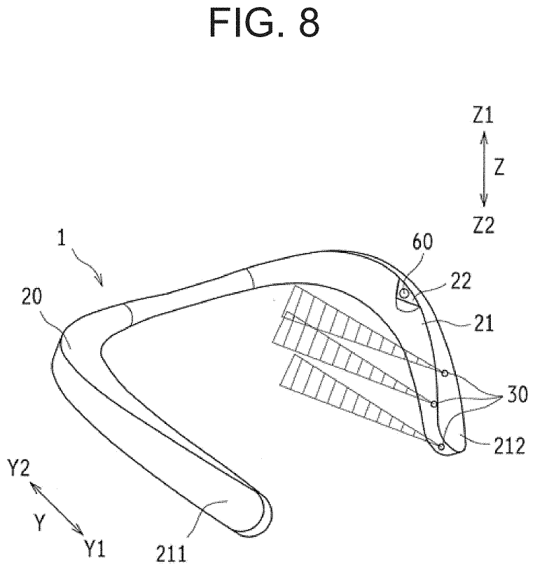

FIG. 7 is a perspective view showing the wearable microphone speaker 1 according to a fourth embodiment, and FIG. 8 is a perspective view showing a modified example of the wearable microphone speaker 1 according to the fourth embodiment.

The wearable microphone speaker 1 may include a speaker not having directionality instead of the speaker unit 40 having directionality. In the example shown in FIG. 7, in the wearable microphone speaker 1, the plurality of first microphones 30 are arranged on the left side attachment portion 212 of the main body 20, and one omnidirectional speaker 60 is arranged in the rear Y2 of those first microphones 30.

The omnidirectional speaker 60 outputs the transmitted sound in an omnidirectional manner, and the wave surface of the sound is propagated in all directions. The omnidirectional speaker 60 is provided on the left side attachment portion 212, just as the plurality of first microphones 30 are. Cost reduction of the wearable microphone speaker 1 can be realized by using the omnidirectional speaker 60.

Moreover, since each of the plurality of first microphones 30 has directionality and is arranged at intervals from one another, any one of the first microphones 30 can pick up the voice of the talker P and can handle the case even in which the talker P talks while moving his/her face.

The plurality of first microphones 30 may not only be aligned linearly on the left side attachment portion 212 but also be provided on the right side attachment portion 211 together with the omnidirectional speaker 60, and as shown in FIG. 8, they may be aligned gradually to the outer side from the front Y1 to the rear Y2. Since the plurality of first microphones 30 are aligned gradually to the outer side from the front Y1 to the rear Y2, the voice can be picked up correspondingly to the position of the mouth when the talker P moves his/her face sideways.

Furthermore, as shown in FIG. 8, in order to arrange the omnidirectional speaker 60 so as to face the ceiling direction (up Z1), a protrusion 22 facing the up Z1 may be provided on the left side attachment portion 212, and the omnidirectional speaker 60 may be arranged on the protrusion 22. Moreover, the direction of the protrusion 22 is not limited to the up Z1, and the omnidirectional speaker 60 can be also arranged toward the rear Y2 by providing the protrusion 22 facing the rear Y2, for example. As a result, an arrangement angle can be set by the protrusion 22 while using the relatively inexpensive omnidirectional speaker 60, and picking-up of the sound by the first microphone 30 can be made difficult, and echo and howling can be reduced.

### Fifth Embodiment

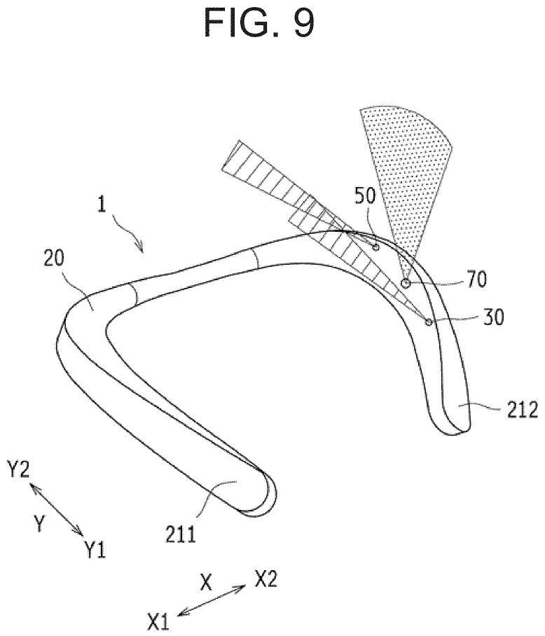

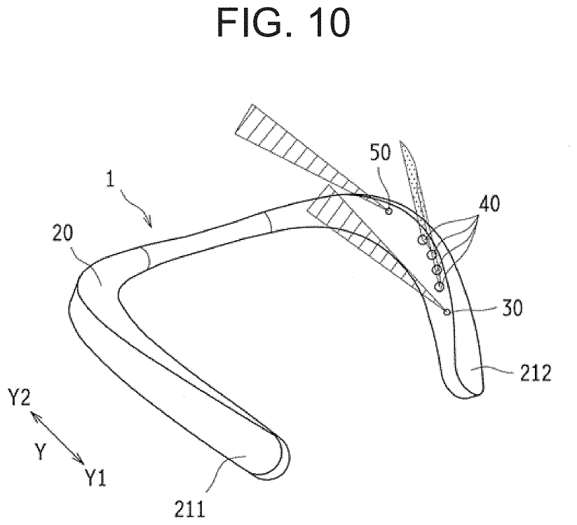

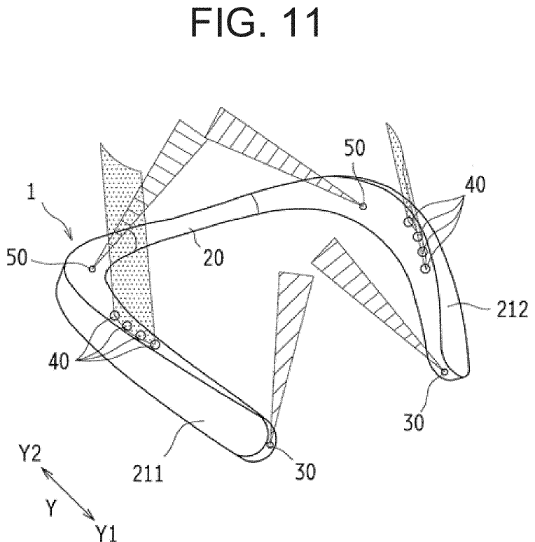

FIG. 9 is a perspective view showing the wearable microphone speaker 1 according to a fifth embodiment, and FIGS. 10 to 11 are perspective views showing modified examples of the wearable microphone speaker 1 according to the fifth embodiment, respectively.

As shown in FIG. 9, the wearable microphone speaker 1 may have such configuration that, for example, the first microphone 30, a directional speaker 70, and the second microphone 50 are aligned in this order from the front Y1 (distal end side) of the left side attachment portion 212 to the rear Y2. The first microphone 30 and the second microphone 50 are arranged in the front-rear direction Y with one directional speaker 70 therebetween. Also, in this case, the directional speaker 70 is preferably disposed at a position corresponding to the down Z2 of the ear of the talker P.

The directional speaker 70 preferably has directionality toward the ear of the talker P, or is installed toward the up Z1 and has an upward directionality. The first microphone 30 and the second microphone 50 are arranged outside the directionality range of the directional speaker 70 and the provision thereof is not limited to one each, but one or both of them may be provided in plural.

By providing a pair of the first microphone 30 and the second microphone 50 in the front-rear direction Y, they can handle talking of the talker P with his/her face directed sideways or while moving his/her face, and movement of the position of the mouth can be followed.

Moreover, as shown in FIG. 10, the wearable microphone speaker 1 may include the speaker unit 40 arranged in an array formation instead of the directional speaker 70. As a result, sound waves can be emitted as a linear sound source, and back pressure interference caused by the adjacent speaker units can be reduced.

Provision of the first microphone 30, directional speaker 70 (or speaker unit 40), and second microphone 50 is not limited to on the left side attachment portion 212, but they may be on the right side attachment portion 211 or on both sides.

For example, as shown in FIG. 11, in the wearable microphone speaker 1, the first microphone 30, the speaker unit 40, and the second microphone 50 may be aligned and configured symmetrically on each of the right side attachment portion 211 and the left side attachment portion 212 in order from the front Y1. In this case, a set of the first microphone 30 and the second microphone 50 of the right side attachment portion 211 and a set of the first microphone 30 and the second microphone 50 of the left side attachment portion 212 may be paired so as to have a configuration that a stereo signal based on outputs of them is generated and recorded in stereo.

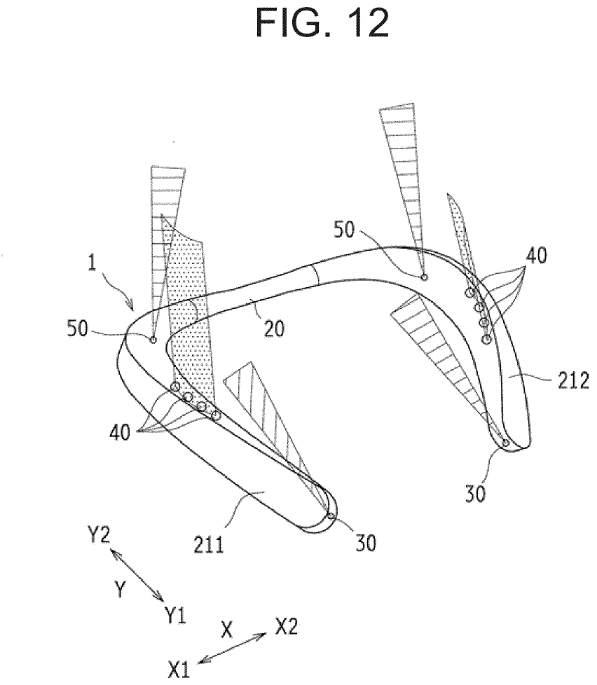

Moreover, as shown in FIG. 12, the directionality of the first microphone 30 on the left side X2 and the corresponding first microphone 30 on the right side X1 may be set to be substantially in parallel, and the directionality of the second microphone 50 on the left side X2 and the corresponding second microphone 50 on the right side X1 may be set to be substantially in parallel so as to have a configuration capable of stereo recording called the A-B method in which a sound pickup axes do not cross each other. Since the wearable microphone speaker 1 has a total of four first microphones 30 and second microphones 50 mounted, a stereo sound signal with a sufficient stereoscopic effect can be obtained.

### Sixth Embodiment

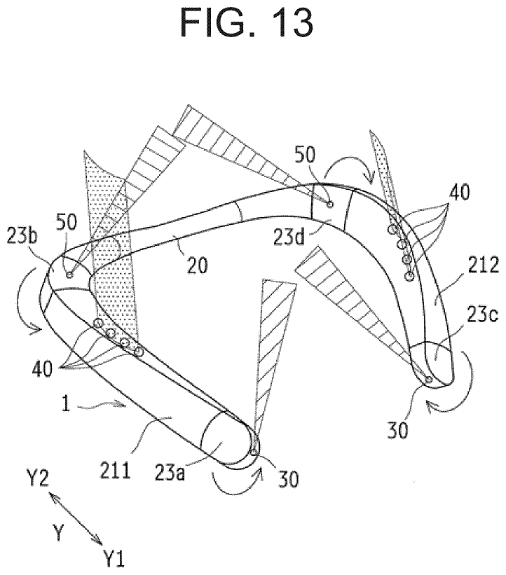

FIG. 13 is a perspective view showing the wearable microphone speaker 1 according to a sixth embodiment.

As shown in FIG. 11, in the form in which the first microphone 30, the speaker unit 40, and the second microphone 50 are provided in order on the right side attachment portion 211 and the left side attachment portion 212 of the wearable microphone speaker 1, respectively, the first microphone 30 and the second microphone 50 may be further provided rotatably. That is, as shown in FIG. 13, in the wearable microphone speaker 1, a portion of the right side attachment portion 211 on which the first microphone 30 is provided constitutes a rotating portion 23a, and a portion on which the second microphone 50 is provided constitutes a rotating portion 23b, and each is made rotatable around an axis of the main body 20. On the left side attachment portion 212, too, a portion on which the first microphone 30 is provided constitutes a rotating portion 23c, and a portion on which the second microphone 50 is provided constitutes a rotating portion 23d, and each is made rotatable around an axis of the main body 20.

All of these rotating portions 23a to 23d can rotate around the axis of the main body 20 and can be fixed by stopping the rotation at an arbitrary angle. Therefore, each directionality of the first microphone 30 and the second microphone 50 can be set to an arbitrary direction.

Moreover, in the example shown in FIG. 13, the two rotating portions 23a and 23c located at the front Y1 may be made extendable to the front Y1 from the main body 20 (right side attachment portion 211 and left side attachment portion 212) so as to be telescopic in the front-rear direction Y. As a result, when the wearable microphone speaker 1 is attached, the sound can be picked up more clearly by adjusting the first microphone 30 and the second microphone 50 to appropriate preferable angles and positions.

As described above, in the wearable microphone speaker 1 according to the embodiments of the present invention, since the first microphone 30 has directionality in the direction of the talker P's mouth, and the speaker unit 40, the directional speaker 70, and the like, are arranged outside the directionality range of the first microphone 30, the voice emitted from the talker P is favorably picked up by the first microphone 30, and the sound emitted from the speaker unit 40, and the like, can be made to easily reach the ear of the talker P. Moreover, since the wearable microphone speaker 1 has a configuration that does not cover the ears, the talker P can speak while listening not only to the sound of the speaker unit 40, and the like, but also to the voices of others and the surrounding sounds, and can make use thereof suitable in conversation with a plurality of people or while moving.

What is claimed is:

1. A wearable microphone speaker, comprising: a main body that can be attached to a talker;
one or a plurality of first microphones that are provided in the main body and pick up voice of the talker; and
one or a plurality of speakers that are provided in the main body and output sound to the talker, wherein
the first microphone has directionality in a direction of the talker's mouth; and
the speaker is arranged outside a directionality range of the first microphone.

2. The wearable microphone speaker according to claim 1, wherein
the speaker has directionality in a direction of the talker's ear.

3. The wearable microphone speaker according to claim 1, wherein
the main body is a neck band type that can be attached to the neck of the talker, and the first microphone is provided on an attachment portion that extends from above the shoulder of the talker to the chest side.

4. The wearable microphone speaker according to claim 3, wherein
a plurality of the first microphones are provided close to a distal end of the attachment portion located on the chest side; and
the first microphone is aligned so as to be closer to an inner side of the attachment portion, toward the distal end side of the attachment portion.

5. The wearable microphone speaker according to claim 3, wherein
a second microphone arranged outside a directionality range of the speaker is provided in the main body; and
the second microphone is arranged on a side opposite to the first microphone with respect to the speaker.

6. The wearable microphone speaker according to claim 5, wherein
the speaker is disposed at a position corresponding to a lower part of the talker's ear; and
the first microphone, the speaker, and the second microphone are aligned on the attachment portion in order from the distal end side.

7. The wearable microphone speaker according to claim 3, wherein the attachment portion is provided rotatably with respect to the main body.

8. The wearable microphone speaker according to claim 3, wherein the attachment portion is provided extendably with respect to the main body.
